(19) United States
(12) Patent Application Publication
(10) Pub. No.: US 2019/0307082 A1
(43) Pub. Date: Oct. 10, 2019

(54) ORIENTAL TOBACCO PRODUCTION METHODS

(71) Applicant: R.J. Reynolds Tobacco Company, Winston-Salem, NC (US)

(72) Inventors: Robert Gary Parker, Burlington, NC (US); Robert Donald McElveen, Georgetown, SC (US); Robert Beardsley Fulford, JR., Winston-Salem, NC (US); Christopher Scott Dixon, Winston-Salem, NC (US)

(21) Appl. No.: 15/946,012

(22) Filed: Apr. 5, 2018

(51) Int. Cl. A01G 22/45; A24B 13/00; A01D 45/16; A01G 9/14; A01G 9/24; A01C 21/00; A01G 24/25; A24B 3/12

(52) U.S. Cl. CPC A01G 22/45; A24B 13/00; A01D 45/16; A01G 9/14; A24F 47/008; A01C 21/00; A01G 24/25; A24B 3/12; A01G 9/24

(57) ABSTRACT

A method of growing Oriental tobacco, is provided. The method can include receiving a plurality of Oriental tobacco seeds; planting the plurality of Oriental tobacco seeds in one or more containers, wherein the containers are located in a greenhouse structure configured to maintain a first temperature of approximately 50-100° F., and a humidity of approximately 50-60%; allowing the seeds to grow into seedlings at least about 4 inches in height; transplanting the seedlings into a coconut core medium, wherein the coconut core medium is located in a greenhouse structure configured to maintain a second temperature of approximately 50-100° F., and a humidity of approximately 50-60%; and allowing the seedlings to grow into Oriental tobacco plants.

### FIELD OF THE INVENTION

The present disclosure relates to products made or derived from tobacco, or that otherwise incorporate tobacco and components of tobacco, and are intended for human consumption.

### BACKGROUND OF THE INVENTION

Cigarettes, cigars, and pipes are popular smoking articles that employ tobacco in various forms. Such smoking articles are employed by heating or burning tobacco to generate aerosol (e.g., smoke) that may be inhaled by the smoker. Popular smoking articles, such as cigarettes, have a substantially cylindrical rod shaped structure and include a charge, roll or column of smokable material such as shredded tobacco (e.g., in cut filler form) surrounded by a paper wrapper thereby forming a so-called “cigarette rod” or “tobacco rod.” Normally, a cigarette has a cylindrical filter element aligned in an end-to-end relationship with the tobacco rod. Typically, a filter element comprises plasticized cellulose acetate tow circumscribed by a paper material known as “plug wrap.” Certain cigarettes incorporate a filter element having multiple segments, and one of those segments can comprise activated charcoal particles. Typically, the filter element is attached to one end of the tobacco rod using a circumscribing wrapping material known as “tipping paper.” It also has become desirable to perforate the tipping material and plug wrap, in order to provide dilution of drawn mainstream smoke with ambient air. A cigarette is employed by a smoker by lighting one end thereof and burning the tobacco rod. The smoker then receives mainstream smoke into his/her mouth by drawing on the opposite end (e.g., the filter end) of the cigarette.

Tobacco also may be enjoyed in a so-called “smokeless” form. Particularly popular smokeless tobacco products are employed by inserting some form of processed tobacco or tobacco-containing formulation into the mouth of the user. See for example, the types of smokeless tobacco formulations, ingredients, and processing methodologies set forth in U.S. Pat. No. 1,376,586 to Schwartz; U.S. Pat. No. 3,696,917 to Levi; U.S. Pat. No. 4,513,756 to Pittman et al.; U.S. Pat. No. 4,528,993 to Sensabaugh, Jr. et al.; U.S. Pat. No. 4,624,269 to Story et al.; U.S. Pat. No. 4,991,599 to Tibbetts; U.S. Pat. No. 4,987,907 to Townsend; U.S. Pat. No. 5,092,352 to Sprinkle, III et al.; U.S. Pat. No. 5,387,416 to White et al.; U.S. Pat. No. 6,668,839 to Williams; U.S. Pat. No. 6,834,654 to Williams; U.S. Pat. No. 6,953,040 to Atchley et al.; U.S. Pat. No. 7,032,601 to Atchley et al.; and U.S. Pat. No. 7,694,686 to Atchley et al.; US Pat. Pub. Nos. 2004/0020503 to Williams; 2005/0115580 to Quinter et al.; 2005/0244521 to Strickland et al.; 2006/0191548 to Strickland et al.; 2007/0062549 to Holton, Jr. et al.; 2007/0186941 to Holton, Jr. et al.; 2007/0186942 to Strickland et al.; 2008/0029110 to Dube et al.; 2008/0029116 to Robinson et al.; 2008/0029117 to Mua et al.; 2008/0173317 to Robinson et al.; 2008/0196730 to Engstrom et al.; 2008/0209586 to Neilsen et al.; 2008/0305216 to Crawford et al.; 2009/0025738 to Mua et al.; 2009/0025739 to Brinkley et al.; 2009/0065013 to Essen et al.; 2009/0293889 to Kumar et al.; 2010/0018540 to Doolittle et al; 2010/0018541 to Gerardi et al.; 2010/0291245 to Gao et al; 2011/0139164 to Mua et al.; 2011/0174323 to Coleman, III et al.; 2011/0247640 to Beeson et al.; 2011/0259353 to Coleman, III et al.; 2011/0303511 to Brinkley et al.; 2012/0037175 to Cantrell et al.; 2012/0055494 to Hunt et al.; 2012/0103353 to Sebastian et al.; 2012/0125354 to Byrd et al.; 2012/0138073 to Cantrell et al.; 2012/0138074 to Cantrell et al; and 2013/0206150 to Duggins et al.; PCT WO 04/095959 to Arnarp et al.; PCT WO 05/063060 to Atchley et al.; PCT WO 05/004480 to Engstrom; PCT WO 05/016036 to Bjorkholm; PCT WO 05/041699 to Quinter et al., and PCT WO 10/132444 to Atchley; each of which is incorporated herein by reference.

One type of smokeless tobacco product is referred to as “snuff.” Representative types of moist snuff products, commonly referred to as “snus,” have been manufactured in Europe, particularly in Sweden, by or through companies such as Swedish Match AB, Fiedler & Lundgren AB, Gustavus AB, Skandinavisk Tobakskompagni A/S, and Rocker Production AB. Snus products available in the U.S.A. have been marketed under the tradenames Camel Snus Frost, Camel Snus Original and Camel Snus Spice by R. J. Reynolds Tobacco Company. See also, for example, Bryzgalov et al., 1N1800 Life Cycle Assessment, Comparative Life Cycle Assessment of General Loose and Portion Snus (2005). In addition, certain quality standards associated with snus manufacture have been assembled as a so-called GothiaTek standard. Representative smokeless tobacco products also have been marketed under the tradenames Oliver Twist by House of Oliver Twist A/S; Copenhagen moist tobacco, Copenhagen pouches, Skoal Bandits, Skoal Pouches, SkoalDry, Rooster, Red Seal long cut, Husky, and Revel Mint Tobacco Packs by U.S. Smokeless Tobacco Co.; Marlboro Snus and “taboka” by Philip Morris USA; Levi Garrett, Peachy, Taylor's Pride, Kodiak, Hawken Wintergreen, Grizzly, Dental, Kentucky King, and Mammoth Cave by American Snuff Company, LLC; Camel Snus, Camel Orbs, Camel Sticks, and Camel Strips by R. J. Reynolds Tobacco Company. Other exemplary smokeless tobacco products that have been marketed include those referred to as Kayak moist snuff and Chatanooga Chew chewing tobacco by Swisher International, Inc.; and Redman chewing tobacco by Pinkerton Tobacco Co. LP.

The tobacco used for tobacco product manufacture is typically used in blended form. For example, certain popular tobacco blends, commonly referred to as “American blends,” comprise mixtures of flue-cured tobacco, burley tobacco and Oriental tobacco, and in many cases, certain processed tobaccos, such as reconstituted tobacco and processed tobacco stems. The precise amount of each type of tobacco within a tobacco blend used for the manufacture of a particular cigarette brand varies from brand to brand. However, for many tobacco blends, flue-cured tobacco makes up a relatively large proportion of the blend, while Oriental tobacco makes up a relatively small proportion of the blend. See, for example, Tobacco Encyclopedia, Voges (Ed.) p. 44-45 (1984), Browne, The Design of Cigarettes, 3^{rd} Ed., p. 43 (1990) and Tobacco Production, Chemistry and Technology, Davis et al. (Eds.) p. 346 (1999).

Oriental tobaccos are desirable components of the tobacco blends of smoking products because Oriental tobaccos yield smoke possessing certain unique and desirable flavor and aroma characteristics. Most Oriental tobaccos have relatively low nicotine content, and relatively high levels of certain reducing sugars, acids, and volatile flavor compounds. Some of the distinct flavors and aroma characteristics of Oriental tobacco smoke are attributed to the presence of sucrose esters in Oriental tobaccos, and the pyrolysis products of those sucrose esters. See, e.g., U.S. Pat. No. 7,025,066 to Lawson et al., which is herein incorporated by reference.

Descriptions of various Oriental tobaccos, growing practices, harvesting practices, and curing practices are set forth in Wolf, Aromatic or Oriental Tobaccos (1962), Akehurst, Tobacco (1968), and Tobacco Encyclopedia, Voges (Ed.) (1999), which are herein incorporated by reference. Typically, Oriental tobaccos are grown in eastern Mediterranean and Asian regions such as Turkey, Greece, Bulgaria, Macedonia, Syria, Lebanon, Italy, Yugoslavia, Romania, and Southeast Asia (e.g., Thailand). For this reason, Oriental tobaccos are also referred to as Greek aromatic and Turkish tobaccos.

Attempts have been made to grow Oriental tobaccos in regions of the world other than the aforementioned representative Mediterranean regions. However, it is believed that the quality of those tobaccos has not been comparable to those tobaccos grown in the Mediterranean and Asian regions. It would be desirable to provide a manner or method for growing Oriental tobaccos, preferably tobaccos with characteristics and quality that are comparable to those that are of the type that have been traditionally grown in the referenced Mediterranean and Asian regions of the World.

### SUMMARY OF THE INVENTION

The present disclosure provides a method of growing Oriental tobacco. The methods described herein can include receiving a plurality of Oriental tobacco seeds; planting the plurality of Oriental tobacco seeds in one or more containers, wherein the containers are located in a greenhouse structure configured to maintain a first temperature of approximately 50-100° F., and a humidity of approximately 50-60%; allowing the seeds to grow into seedlings at least about 4 inches in height; transplanting the seedlings into a coconut core medium, wherein the coconut core medium is located in a greenhouse structure configured to maintain a second temperature of approximately 50-100° F., and a humidity of approximately 50-60%; and allowing the seedlings to grow into Oriental tobacco plants. In various embodiments of the methods described herein, the seedlings are allowed to grow until they are approximately 5 inches in height. Various embodiments of methods disclosed herein can further include harvesting the Oriental tobacco plants to provide harvested Oriental tobacco leaves. Some embodiments can further include curing the harvested Oriental tobacco leaves. In some embodiments, the method can further include aging the harvested Oriental tobacco leaves.

In various embodiments of the methods described herein, the first temperature can be varied between a first setting and a second setting over the course of a 24 hour cycle. For example, the first setting can be approximately 50-70° F. In some embodiments, the second setting can be approximately 80-100° F. In various embodiments, the first setting can be a period of approximately 12 hours and the second setting can be a period of approximately 12 hours. In certain embodiments, the period for each setting is based on approximate temperatures as impacted by sunlight in regions where Oriental tobacco is typically grown (i.e., the temperature settings are not a function of time).

In some embodiments of the methods described herein, the second temperature can be varied between a first setting and a second setting over the course of a 24 hour cycle. For example, the first setting can be approximately 50-70° F. In some embodiments, the second setting can be approximately 80-100° F. In various embodiments, the first setting can be a period of approximately 12 hours and the second setting can be a period of approximately 12 hours.

Various embodiments of the methods described herein can further include incorporating the Oriental tobacco into a tobacco product. In some embodiments, the tobacco product can be a smoking article. The smoking article can have, for example, sensory characteristics comparable to those of a smoking article incorporating Oriental tobacco grown in Mediterranean or Asian regions using conventional growth methods. In various embodiments, the tobacco product can be a smokeless tobacco product.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only, and should not be construed as limiting the invention.

FIG. 1 is a flow chart describing representative methods of the present disclosure for growing Oriental tobacco;

FIG. 2 is an exploded perspective view of a smoking article having the form of a cigarette, showing the smokable material, the wrapping material components, and the filter element of the cigarette;

FIG. 3 is a top view of a smokeless tobacco product embodiment, taken across the width of the product, showing an outer pouch filled with a tobacco material;

FIG. 4 is a sectional view through an electronic smoking article comprising a cartridge and a control body and including a reservoir housing according to an example embodiment of the present disclosure;

FIG. 5 is a photo showing Oriental tobacco plants grown in a greenhouse using organic potting soil as a soil medium;

FIG. 6 is a photo showing Oriental tobacco plants grown in a greenhouse using coconut core media as a soil medium; and

FIG. 7 is a photo showing a curing setup of Oriental tobacco plants grown in a greenhouse using coconut core media as a soil medium.

### DETAILED DESCRIPTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise. Reference to “dry weight percent” or “dry weight basis” refers to weight on the basis of dry ingredients (i.e., all ingredients except water).

The present disclosure provides methods for growing Oriental tobaccos. In particular, methods of the present disclosure allow for growth of Oriental tobaccos outside of regions wherein such tobaccos are typically grown (e.g., methods described herein can allow for growth of Oriental tobaccos in North America, including the United States). Tobacco plants can be grown in greenhouses, growth chambers, or outdoors in fields, or grown hydroponically. Representative Oriental tobaccos that can be grown in accordance with the present disclosure include, but are not limited to, the Izmir, Basma, Mavra, and Samsun varieties. Other representative Oriental tobaccos that can be grown according to methods disclosed herein include, but are not limited to, Trabzon, Thesalian, Tasova, Sinop, Izmit, Hendek, Edirne, Semdinli, Adiyanman, Yayladag, Iskenderun, Duzce, Macedonian, Katerini, Prilep, Komotini, Xanthi, Yambol, Krumovgrad, Bafra, Bursa, Bucak, Bitlis, and Balikesir tobaccos, as well as the so-called semi-Oriental tobaccos such as Sebinkarahisar, Borgka, and East Balkan tobaccos.

Oriental tobaccos that are grown in accordance with the present disclosure are grown in regions of the world other than those Mediterranean and Asian regions where good quality Oriental tobaccos typically are grown. Of particular interest are countries such as the continental United States of America. In various methods of the present disclosure, Oriental tobaccos are grown under controlled conditions. By this is meant that those tobaccos are grown in environmental/climatic conditions that are capable of being modified/controlled. Such conditions include exposure to light, temperature, humidity, access to water, soil conditions, availability to nutrients, and the like.

As described in more detail below, methods of growing Oriental tobacco outside of conventional regions where good quality Oriental tobaccos typically are grown include planting Oriental tobacco seeds in a seed tray located in a greenhouse. Controlled conditions can be provided inside the greenhouse such that the seeds can effectively grow into seedlings. The seedlings can then be transplanted from the trays and planted as individual plants inside a soil medium located inside the greenhouse. Again, optimal growing conditions for the Oriental tobacco seedlings can be adjusted within the greenhouse. The Oriental tobacco plants can then be allowed to grow until the plants are ready to harvest. Typically tobacco plants can be harvested when they reach a pre-determined size. In some embodiments, plants are considered ready to harvest after a set period of time. In some embodiments, harvest is initiated as the lower leaves begin to change color due to chlorophyll degradation as part of plant senescence. In the case of Oriental tobacco, only a slight change in leaf color can indicate ripeness. The mature plants can be harvested weekly as the leaves ripen. If desired, the harvested tobacco leaves can be cured and optionally aged.

Controlled conditions typically can be provided by the use of a greenhouse. As used herein, the term “greenhouse” is used to refer to a structural building comprising at least a partial covering material which can be transparent or semi-transparent (e.g., a glass or a plastic roof) and frequently glass or plastic walls. The interior of the greenhouse can heat up because incoming visible sunshine is absorbed inside the structure. Air warmed by the heat from warmed interior surfaces is retained in the building by the roof and walls and the air that is warmed near the ground is prevented from rising indefinitely and flowing away. Additional sources of heat can be provided for a greenhouse, as are known in the art. Depending upon the technical specification of a greenhouse, key factors which may be controlled include, but are not limited to, temperature, levels of light and shade, irrigation, fertilizer application, and atmospheric humidity. See, e.g., U.S. Pat. No. 5,038,517 to Talbott, and U.S. Pat. No. 6,185,877 to Lloyd, which are herein incorporated by reference. Production of Oriental tobaccos in a greenhouse according to methods of the present invention, can provide growers with the opportunity to produce another tobacco crop in their greenhouses during the spring, summer, and fall months when the greenhouse is not being used for traditional tobacco plant production. Along with giving the grower another source of income, it would offset the fixed cost of the greenhouse by providing the grower, in some embodiments, with year round usage.

### Traditional Production Methods

For comparison to the inventive methods described herein, an overview of traditional methods for growing Oriental tobacco plants is provided. Oriental tobaccos are traditionally grown in climates that are considered to be semi-arid. As used herein, a semi-arid climate, also referred to as a steppe climate, is a climate of a region that receives precipitation below potential evapotranspiration, but not extremely below (e.g., 10-20 in of rainfall annually). Semi-arid climates are intermediates between desert climates and humid climates in ecological characteristics and agricultural potential. Semi-arid climates tend to support short or scrubby vegetation, which can be desirable for Oriental tobaccos. Oriental tobaccos are grown during seasons that are considered to be summer. In general, growing Oriental tobaccos are subjected to about 10-14 hours, or 12-14 hours of light per day during pre-harvest and harvest season (e.g., June and July).

A traditional Oriental tobacco growth method (e.g., a growth method for plants outside in a field) begins with providing a seed bed comprising hand formed beds, and spreading fertilizer (e.g., manure) mixed with sand over the bed. Mixing tobacco seeds with additional sand and spreading the mixture uniformly over the bed or mixing tobacco seeds with water (e.g., in a watering can) and sprinkling the mixture over the bed are two example ways to uniformly apply seeds to a seed bed. Once the seeds are spread on top of the bed, a plastic cover can be pulled over to simulate greenhouse conditions.

In the production phase for traditional Oriental tobacco growth methods, transplants are hand pulled and transplanted by hand or using a mechanical transplanter directly into the ground. In some embodiments, planting density can be about 114,000 plants per acre. Fertilizer can be applied and is often in the form of organic carryover from the previous crop. Overhead irrigation can be set up if needed. Synthetic insecticides can be used as necessary.

In the harvesting and curing phases for traditional Oriental tobacco growth methods, about 4 to 6 leaves can be harvested from a plant each time a plant is harvested. A plant is typically harvested about 5 to 6 times over the course of several weeks as the leaves mature. The harvested leaves can then be sewn on a string using a stringing machine, for example, and hung in a curing structure to cure. Leaves are sometimes put in the shade for a day to wilt and lose moisture before they are subjected to curing. The leaves can be cured for approximately 3 to 4 weeks. See, e.g., Davis, D. L., and M. T. Nielson, Tobacco Production, Chemistry and Technology, pp. 154-163, Pub. 1999, which are herein incorporated by reference in their entireties.

### Inventive Method of Growing Oriental Tobaccos

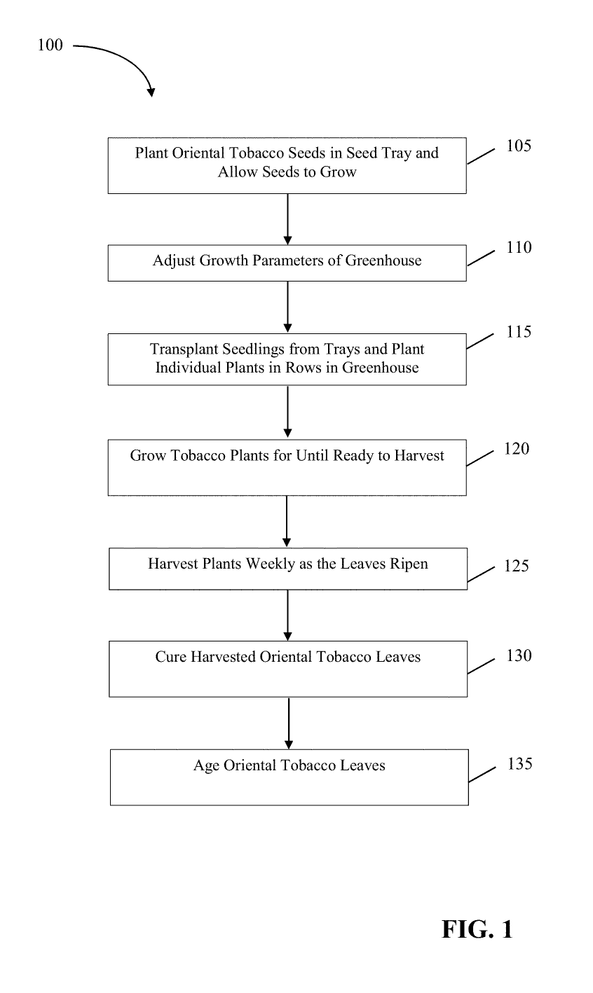

As illustrated in FIG. 1, growth method 100 described herein generally comprises providing Oriental tobacco seeds for use in a greenhouse. Seeds for the Oriental tobaccos can be obtained from various sources, including but not limited to the Tobacco Germplasm Collection preserved by North Carolina State University, for example. Seeds can optionally be pelleted using the conventional method of adding inert clay particles in order to increase the size of the seed, which increases handling and planting efficiency. See, e.g., A. G. Taylor et al., “Seed Enhancements”, Seed Science Research Vol 8 issue 2 (1998), which is herein incorporated by reference.

As illustrated at operation 105 of Oriental tobacco growth method 100, for example, Oriental tobacco seeds can be planted in a seed tray for initial growth. Typically, seed trays comprising clay coated tobacco seeds planted therein can be laid in a float bed in a greenhouse. See, e.g., Tobacco Science, Jones, M. A., G. S. Miner, and W. D. Smith, Production of Flue-Cured Tobacco Seedlings in Greenhouses, Effects of Media and Fertilization on The Direct Seeded Float System. pp. 13-17. (Tob. Sci. 37:13-17 1993), which is herein incorporated by reference in its entirety. In the method of the present disclosure, the seeds are coated for use with a traditional seeder (organic coating, for example), and then seeded in a tray using a growth medium (e.g., an organic medium) and optionally a fertilizer. In one embodiment, seeds are placed in a polystyrene tobacco seed tray. Seeds can grow to seedlings of 3-4 inches in height before transplanting. The plants are mowed (e.g., using a lawn mower with a bagging attachment suspended by a rail system) in some embodiments prior to transplanting to increase uniformity and usability. See, e.g., Tob. Sci., Suggs et. al., Tobacco Transplants. Part 3. Effects of Clipping and Undercutting on Yield, Value, Chemistry and Growth. pp. 24-28, which is herein incorporated by reference in its entirety.

As illustrated at operation 115 of Oriental tobacco growth method 100, for example, after about 40-45 days time, the young plants are transplanted into a growth medium. This means removing seedlings from the trays and planting individual plants (e.g., in rows) into a growth medium inside the greenhouse. For example, they may be transplanted into an organic certified coconut core bag, as described in more detail below.

Preferred soil conditions for growing the Oriental tobacco plants can be rocky, poor, and somewhat infertile soil containing minimal amounts of nitrogen and organic matter. Soil should provide good drainage. See, e.g., Tobacco Production, Chemistry and Technology: Ed. Davis, D. L., and M. T. Nielson, pp. 154-163, 1999, which is herein incorporated by reference in its entirety. The growth medium that the Oriental tobacco seedlings are transplanted in according to the presently disclosed method can vary. In certain embodiments, organic growth media can be used. In some embodiments, coconut core media can be used. See, e.g., http://www.cocoagro.com/cocopeat-grow-bags.html, which is herein incorporated by reference. In general, it is desirable in some embodiments for the growth medium to be organically certified and to contain little or no fertilizer (i.e., to be substantially free of any fertilizer). As such, the exact amount and type of fertilizer(s) used can be controlled.

In some embodiments, a trickle tube irrigate can be inserted among the plants for application of water and nutrients. Fertilizer, e.g., liquid organic fertilizer, can be applied as necessary. Insect management can also be utilized in some embodiments. In certain embodiments, the density of the plants is about 3.5 inches between each plant within the row and 18 inches or less between rows.

As illustrated at operation 110 of Oriental tobacco growth method 100, for example, the growth parameters within the greenhouse can be adjusted to provide preferred growing conditions for Oriental tobaccos. Temperature can be controlled within the greenhouse to mimic traditional growth temperatures (e.g., those temperatures of the Mediterranean and Asian regions where Oriental tobaccos are typically grown). The temperature at which Oriental tobaccos are typically grown at can vary. For example, growth temperatures can range from about 50-70° F., or about 60-65° F. at night to 85-100° F. during the day. In some embodiments, the temperature can be maintained between 60-100° F. at all times. In some embodiments, the temperature of the greenhouse is adjusted so as to provide for a hotter environment during the day and a cooler environment during the night to mimic the conditions of the regions Oriental tobacco is typically grown in. For example, in some embodiments, heaters can be used in a greenhouse when it is necessary to increase growth during cooler weather, thereby allowing for multiple crops within a given year. If increased temperatures are necessary, the plants can be subjected to the higher temperature setting for a longer period of time (e.g., 18 hours) than the period of time the plants are subjected to the lower temperature setting in a 24 hour cycle. In some embodiments, the temperature settings are not controlled as a function of time. For example, the temperature settings may be controlled simply to maintain the desired maximum/minimum temperature regime as impacted by sunlight. Accordingly, the temperature conditions in the greenhouse could more closely mimic growing conditions during the growing season in the regions Oriental tobacco is typically grown in. During the summer for example, the average temperature outside the greenhouse can be greater due to longer day length and, in such embodiments, less heating is required to maintain the desired temperature. Increased light exposure (e.g., growing lamps) could also be used in combination with temperature adjustments or instead of temperature adjustments to assist with the grow process.

Humidity can be controlled within the greenhouse to mimic traditional humidity levels during growth of Oriental tobaccos. Humidity can vary for preferred growing conditions of Oriental tobacco. Humidity during growth of Oriental tobaccos can range from about 30 to about 50 percent, or from about 35 to about 45 percent. Again, within the greenhouse, humidity can be controlled, e.g., by a misting system (to increase humidity) and ventilation or a dehumidifier (to decrease humidity). In some embodiments, the greenhouse can be equipped with fans to provide circulation. In some embodiments, a more uniform humidity can be provided in the greenhouse during growth of the Oriental tobacco. In various embodiments, the humidity in the greenhouse can be varied over the course of growing the Oriental tobacco.

In various embodiments of the methods described herein, nutrients can be applied during growth of the Oriental tobaccos, e.g., directly onto plants and/or to the soil/growth medium. Various nutrients can be used in Oriental tobacco growing processes, such as, but not limited to, nitrogen, potassium, phosphate, and combinations thereof, along with other plant essential nutrients. For example, nutrients used can include, but are not limited to, 5-2-5 (nitrogen, phosphorous, and potassium NPK blend) plus 0-0-50 sulphate of potash plus 15-0-0 sodium nitrate. In some embodiments, about 20-25 lbs of nitrogen per acre, about 30-40 lbs of phosphorous per acre, and/or about 135-150 lbs of potassium per acre can be used. Representative amounts are 22 lbs N, 30 lbs P, and 135 lbs K. This amount would, in certain embodiments, support approximately 42,000 plants per acre on average.

In some embodiments, nutrients useful in the methods described herein can be provided by organic or inorganic fertilizer (various types can include blood mill, cotton seed mill, bat or seabird guano, fish mill, etc.). In some embodiments, nutrients provided by fertilizer can be used in combination with organic sulphate of potash and/or organic sodium nitrate. In certain embodiments, fertilizer can be excluded from the nutrients provided to the plants. In some embodiments, one or more nutrients are provided together (e.g., in the same organic fertilizer composition). In other embodiments, two or more nutrients are added separately (e.g., in separate compositions and/or at different times). Nutrients can be applied to the plants and/or soil/growth medium once during growth, or at two or more points during the growth process. In come embodiments, no added nutrients (e.g., outside of those that may be provided in the soil/growth medium) are applied to the plants and/or soil medium. In certain embodiments, nutrients can be applied to the plants and/or soil/growth medium with water (e.g., during irrigation).

In various embodiments, early plant growth can require about 70-100 gallons of irrigation per acre per day up to about 350-400 gallons of irrigation per acre per day. In certain preferred embodiments, the amount of water applied to the plants and/or to the soil/growth medium during plant growth is about 3-5 oz, e.g., about 4.2 oz, per plant twice a week. The amount of water applied can vary over the course of growth. For example, after harvesting begins, about 8-12 oz, e.g., about 11 oz, of water can be applied per plant twice a week. Water can be provided, e.g., by trickle tube irrigation, as is known in the art.

As illustrated at operation 120 of Oriental tobacco growth method 100, for example, the Oriental Tobacco plants are allowed to grow until the plants have matured. A plant can be considered mature when the leaf has reached normal size and begins to ripen, which is a senescence of the leaf. Maturity can represent the point when the leaf is ready to harvest and can be indicated by a lighter color leaf which breaks cleanly from the stalk. See, e.g., Tobacco Production, Chemistry and Technology: Ed. Davis, D. L., and M. T. Nielson, pp. 154-163. Pub. 1999, which is herein incorporated by reference in its entirety. In certain embodiments, the tobacco plant is grown for about 6 weeks after the seedlings are transplanted into the beds.

As illustrated at operation 125 of Oriental tobacco growth method 100, for example, the mature plants are then harvested. The plants can be harvested from bottom to top with 4-6 leaves removed weekly as the leaves ripen. This process can take about 5-6 weeks from the first harvest. There can be about 5-6 harvests during a season.

As illustrated at operation 130 of Oriental tobacco growth method 100, for example, the harvested Oriental tobacco leaves can be cured. In certain embodiments, the harvested Oriental tobacco leaves can be sun cured. See, e.g., Tobacco Production, Chemistry and Technology: Ed. Davis, D. L., and M. T. Nielson, pp. 154-163, 1999, which is herein incorporated by reference in its entirety. Curing can involve stringing or filling a netting with harvested leaves. The leaves can be hung in a curing structure in the sun for approximately one week to yellow. In some embodiments, the curing structure can be covered with plastic, for example, to increase heat and a dehumidifier can be used to reduce humidity to about 30% in order for the leaves to dry. The leaves can be cured for approximately 4 to 6 weeks. In some embodiments, the leaves can be cured approximately 2-3 additional weeks depending on stalk position. Stalk position refers to the part of the plant from which the leaves are removed. During the grown of tobacco plants, the leaves will begin to ripen at the bottom and then continue to ripen up the stalk. The leaves can be harvested 4-6 leaves at a time, going from the bottom to the top of the stalk. The leaves can increase in thickness higher up the stalk. Conditions for curing can be approximately 30-40 percent humidity and a daytime temperature between about 90-100 degrees F. Typically, tobaccos can be cured for about 4 to about 6 weeks.

As illustrated at operation 135 of Oriental tobacco growth method 100, for example, cured (e.g., sun cured) Oriental tobaccos can be aged, e.g., for at least one year after curing is complete. Aging processes can help to enhance the flavors and the burning qualities of tobaccos, for example. Aging can involve storing processed tobacco in a box with a set density in a controlled warehouse until needed. See, e.g., Tobacco Production, Chemistry and Technology: Ed. Davis, D. L., and M. T. Nielson, pp. 154-163, 1999, which is herein incorporated by reference in its entirety. In both traditional methods and methods of the present disclosure, the cured tobacco leaves can then be bulked down in a dark room, water can be applied to the tobacco, and then the tobacco can be separated by stalk position and quality and boxed for delivery to buyers.

Oriental tobaccos grown in accordance with the present disclosure show similar chemistry and flavor characteristics to traditionally grown Oriental tobaccos. It is noted that Oriental tobacco growth methods described herein can allow for Oriental tobacco to be organically grown. See, e.g., Organic 101: What the USDA Organic Label Means (https://www.usda.gov/media/blog/2012/03/22/organic-101-what-usda-organic-label-means), which is herein incorporated by reference in its entirety. It is further noted that growing plants in a greenhouse can allow growers to bypass the normal three year organic certification process necessary for getting organic certifications for plants grown outside of greenhouses or similar structures.

The present disclosure provides methods which can allow growers to provide Oriental tobacco (e.g., organic Oriental tobacco) in the U.S. for use in various tobacco products. Advantageously, such methods can provide tobacco with sensory characteristics comparable to those of Oriental tobaccos typically grown in Mediterranean and Asian regions. As described above, methods of the present disclosure can also allow growers the opportunity to produce another tobacco crop in their greenhouses during the spring, summer, and fall months when the greenhouse is not being used for traditional tobacco plant production.

### Products Incorporating Oriental Tobaccos According to Methods of the Present Invention

Oriental tobaccos grown and processed according to methods outlined herein can be directly used and/or processed for use in various tobacco products. The portion or portions of the Oriental plant of the Nicotiana species used in tobacco products according to the present invention can vary. For example, virtually all of the plant (e.g., the whole plant) can be harvested, and employed as such. Alternatively, various parts or pieces of the plant can be harvested or separated for further use after harvest. For example, the leaves, stem, stalk, roots, lamina, flowers, seed, and various portions and combinations thereof, can be isolated for further use or treatment. The plant material of the invention may thus comprise an entire plant or any portion of a plant of the Nicotiana species. See, for example, the portions of tobacco plants set forth in U.S. Pat. No. 8,955,523 to Coleman, III et al. and U.S. Pat. No. 9,107,453 to Dube et al., which are incorporated by reference herein.

The Oriental tobacco material can be employed in either an immature or mature form, and can be used in either a green form or a cured form, as described in U.S. Pat. No. 9,107,453 to Dube et al., which is incorporated by reference herein.

The Oriental tobacco material can be subjected to various treatment processes such as, refrigeration, freezing, drying (e.g., freeze-drying or spray-drying), irradiation, yellowing, heating, cooking (e.g., roasting, frying or boiling), fermentation, bleaching, or otherwise subjected to storage or treatment for later use. Exemplary processing techniques are described, for example, in U.S. Pat. No. 7,946,295 to Brinkley et al. and U.S. Pat. No. 8,955,523 to Coleman, III et al., which are incorporated by reference herein.

Oriental tobacco materials can be treated with enzymes and/or probiotics before or after harvest, as discussed in US Pat. Appl. Pub. Nos. 2013/0269719 Marshall et al. and 2014/0020694 to Moldoveanu, which are incorporated herein by reference. Tobacco materials may be irradiated, pasteurized, or otherwise subjected to controlled heat treatment. Representative processes are set forth in US Pat. Pub. Nos. 2009/0025738 to Mua et al.; 2009/0025739 to Brinkley et al.; and 2011/0247640 to Beeson et al., which are incorporated herein by reference. In one embodiment, the tobacco material is heat treated in the presence of water, NaOH, and an additive (e.g., lysine) at about 88° C. for about 60 minutes. Such heat treatment can help prevent acrylamide production resulting from reaction of asparagine with reducing sugars in tobacco materials and can provide some degree of pasteurization. See, for example, US Pat. Pub. No. 2010/0300463 to Chen et al., which is incorporated herein by reference. The tobacco material can be brought into contact with an imprinted polymer or non-imprinted polymer such as described, for example, in US Pat. Pub. Nos. 2007/0186940 to Bhattacharyya et al; 2011/0041859 to Rees et al.; 2011/0159160 to Jonsson et al; and 2012/0291793 to Byrd et al., all of which are incorporated herein by reference.

A harvested portion or portions of the Oriental tobacco plant can be physically processed. A portion or portions of the plant can be separated into individual parts or pieces (e.g., roots can be removed from stalks, stems can be removed from stalks, leaves can be removed from stalks and/or stems, petals can be removed from the remaining portion of the flower). The harvested portion or portions of the plant can be further subdivided into parts or pieces (e.g., shredded, cut, comminuted, pulverized, milled or ground into pieces or parts that can be characterized as filler-type pieces, granules, particulates or fine powders). The harvested portion or portions of the plant can be subjected to external forces or pressure (e.g., by being pressed or subjected to roll treatment). When carrying out such processing conditions, the harvested portion or portions of the plant can have a moisture content that approximates its natural moisture content (e.g., its moisture content immediately upon harvest), a moisture content achieved by adding moisture to the harvested portion or portions of the plant, or a moisture content that results from the drying of the harvested portion or portions of the plant.

In certain embodiments, the Oriental tobacco material is used in a form that can be described as particulate (i.e., shredded, ground, granulated, or powder form). The manner by which the tobacco material is provided in a finely divided or powder type of form may vary. Preferably, plant parts or pieces are comminuted, ground or pulverized into a particulate form using equipment and techniques for grinding, milling, or the like. Most preferably, the plant material is relatively dry in form during grinding or milling, using equipment such as hammer mills, cutter heads, air control mills, or the like. For example, tobacco parts or pieces may be ground or milled when the moisture content thereof is less than about 15 weight percent or less than about 5 weight percent. Most preferably, the tobacco material is employed in the form of parts or pieces that have an average particle size less than about 50 microns. In one embodiment, the average particle size of the tobacco particles may be less than or equal to about 25 microns. In some instances, the tobacco particles may be sized to pass through a screen mesh. If desired, air classification equipment may be used to ensure that small sized tobacco particles of the desired sizes, or range of sizes, may be collected. If desired, differently sized pieces of granulated tobacco may be mixed together. Use of micro-milled tobacco particles can be advantageous where the user prefers to reduce or eliminate product waste after use.

In certain embodiments, at least a portion of the Oriental tobacco material can have the form of an extract. Tobacco extracts can be obtained by extracting tobacco using a solvent having an aqueous character such as distilled water or tap water. As such, aqueous tobacco extracts can be provided by extracting tobacco with water, such that water-insoluble pulp material is separated from the aqueous solvent and the water-soluble and dispersible tobacco components dissolved and dispersed therein. Exemplary techniques for extracting components of tobacco are described in U.S. Pat. No. 4,144,895 to Fiore; U.S. Pat. No. 4,150,677 to Osborne, Jr. et al.; U.S. Pat. No. 4,267,847 to Reid; U.S. Pat. No. 4,289,147 to Wildman et al.; U.S. Pat. No. 4,351,346 to Brummer et al.; U.S. Pat. No. 4,359,059 to Brummer et al.; U.S. Pat. No. 4,506,682 to Muller; U.S. Pat. No. 4,589,428 to Keritsis; U.S. Pat. No. 4,605,016 to Soga et al.; U.S. Pat. No. 4,716,911 to Poulose et al.; U.S. Pat. No. 4,727,889 to Niven, Jr. et al.; U.S. Pat. No. 4,887,618 to Bernasek et al.; U.S. Pat. No. 4,941,484 to Clapp et al.; U.S. Pat. No. 4,967,771 to Fagg et al.; U.S. Pat. No. 4,986,286 to Roberts et al.; U.S. Pat. No. 5,005,593 to Fagg et al.; U.S. Pat. No. 5,018,540 to Grubbs et al.; U.S. Pat. No. 5,060,669 to White et al.; U.S. Pat. No. 5,065,775 to Fagg; U.S. Pat. No. 5,074,319 to White et al.; U.S. Pat. No. 5,099,862 to White et al.; U.S. Pat. No. 5,121,757 to White et al.; U.S. Pat. No. 5,131,414 to Fagg; U.S. Pat. No. 5,131,415 to Munoz et al.; U.S. Pat. No. 5,148,819 to Fagg; U.S. Pat. No. 5,197,494 to Kramer; U.S. Pat. No. 5,230,354 to Smith et al.; U.S. Pat. No. 5,234,008 to Fagg; U.S. Pat. No. 5,243,999 to Smith; U.S. Pat. No. 5,301,694 to Raymond et al.; U.S. Pat. No. 5,318,050 to Gonzalez-Parra et al.; U.S. Pat. No. 5,343,879 to Teague; U.S. Pat. No. 5,360,022 to Newton; U.S. Pat. No. 5,435,325 to Clapp et al.; U.S. Pat. No. 5,445,169 to Brinkley et al.; U.S. Pat. No. 6,131,584 to Lauterbach; U.S. Pat. No. 6,284,875 to Turpen et al.; U.S. Pat. No. 6,298,859 to Kierulff et al.; U.S. Pat. No. 6,772,767 to Mua et al.; U.S. Pat. No. 6,817,970 to Berit et al.; U.S. Pat. No. 6,906,172 to Bratcher et al.; U.S. Pat. No. 7,034,128 to Turpen et al.; U.S. Pat. No. 7,048,211 to Bratcher et al.; and U.S. Pat. No. 7,337,782 to Thompson, all of which are incorporated by reference herein. See also, the ultrafiltered translucent tobacco extracts set forth in U.S. Pat. Nos. 9,084,439 and 9,474,303, both to Holton, Jr., which are incorporated by reference herein.

The tobacco-derived extract will typically comprise a mixture of desired components isolated from the Oriental tobacco by various means. However, if desired, the tobacco-derived extract can be highly purified with respect to a single component of the extract or a small number of extract components. Typical separation processes that can further purify or isolate components of a tobacco extract include one or more process steps such as solvent extraction (e.g., using polar solvents, organic solvents, or supercritical fluids), chromatography (e.g., preparative liquid chromatography), clarification, distillation, filtration (e.g., ultrafiltration), recrystallization, and/or solvent-solvent partitioning. In some embodiments, a plant or a portion thereof is pre-treated, e.g., to liberate certain compounds to make the desired compounds available for more efficient separation. In some embodiments, multiple methods are used to isolate and/or purify the desired compounds. See, for example, the description of isolated tobacco components and techniques for isolation in US Pat. Appl. Pub. Nos. 2011/0174323 to Coleman, III et al.; 2011/0259353 to Coleman, III et al.; 2012/0192880 to Dube et al.; 2012/0192882 to Dube et al.; and 2012/0211016 to Byrd, Jr. et al., which are incorporated by reference herein.

In various embodiments, the Oriental tobacco materials can be blended with another form of a plant of the Nicotiana species. The selection of the plant from the Nicotiana species can vary; and in particular, the types of tobacco or tobaccos may vary. Other tobaccos that can be employed include flue-cured or Virginia (e.g., K326), burley, sun-cured (e.g., Indian Kurnool and traditionally grown Oriental tobaccos, including Katerini, Prelip, Komotini, Xanthi and Yambol tobaccos), Maryland, dark, dark-fired, dark air cured (e.g., Passanda, Cubano, Jatin and Bezuki tobaccos), light air cured (e.g., North Wisconsin and Galpao tobaccos), Indian air cured, Red Russian and Rustica tobaccos, as well as various other rare or specialty tobaccos. Additional information on types of Nicotiana species suitable for use in the present invention can be found in U.S. Pat. No. 9,107,453 to Dube et al., which is incorporated by reference herein.

In certain embodiments, the Oriental tobacco materials included in tobacco products can further include nicotine in any form from any source, whether tobacco-derived or synthetically-derived. Normally, nicotinic compounds used in the present invention are selected from the group consisting of nicotine base, nicotine hydrochloride, nicotine dihydrochloride, nicotine monotartrate, nicotine bitartrate, nicotine sulfate, nicotine zinc chloride such as nicotine zinc chloride monohydrate and nicotine salicylate. In some embodiments, nicotine is in its free base form, which can optionally be sorbed on a carrier (e.g., microcrystalline cellulose) for inclusion in a tobacco material. See, for example, the nicotine/carrier compositions set forth in U.S. Pat. No. 8,741,348 to Hansson, which is incorporated by reference herein.

In addition to the above-noted Oriental tobacco material, materials of the disclosure can include a further non-tobacco botanical material. As used herein, the term “botanical material” refers to any plant material, including plant material in its natural form and plant material derived from natural plant materials, such as extracts or isolates from plant materials or treated plant materials (e.g., plant materials subjected to heat treatment, fermentation, or other treatment processes capable of altering the chemical nature of the material). See, e.g., exemplary botanical materials disclosed in U.S. Pat. Pub. No. 2015/0068544 to Moldoveanu et al., herein incorporated by reference. When present in the composition, such botanical materials can be used in the same forms noted above with respect to tobacco (e.g., milled particulates or extracts) and the amounts utilized can depend on the desired use of the tobacco material.

Depending on the type of tobacco material being processed, the tobacco material can include one or more additional components in addition to the tobacco material. For example, the tobacco material can be processed, blended, formulated, combined and/or mixed with other materials or ingredients, such as other tobacco materials or flavorants, fillers, binders, pH adjusters, buffering agents, salts, sweeteners, colorants, disintegration aids, humectants, and preservatives (any of which may be an encapsulated ingredient). See, for example, those representative components, combination of components, relative amounts of those components and ingredients relative to tobacco, and manners and methods for employing those components, set forth in US Pat. Pub. Nos. 2011/0315154 to Mua et al. and 2007/0062549 to Holton, Jr. et al. and U.S. Pat. No. 7,861,728 to Holton, Jr. et al., each of which is incorporated herein by reference.

Oriental tobacco materials produced as described above can be useful in various tobacco products. The tobacco product to which the materials described herein are added can vary, and can include any product configured or adapted to deliver tobacco or some component thereof to the user of the product. Exemplary tobacco products include smoking articles (e.g., cigarettes), smokeless tobacco products, and aerosol-generating devices that contain a tobacco material or other plant material that is not combusted during use.

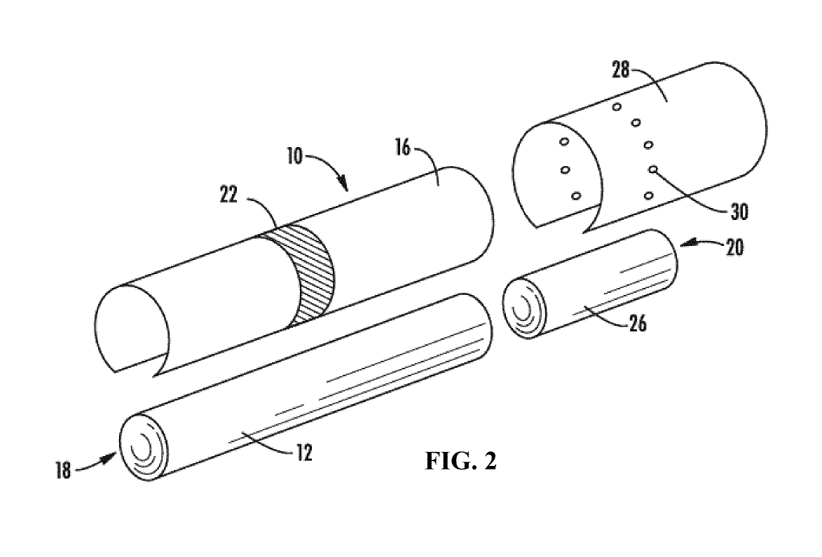

Referring to FIG. 2, there is shown a smoking article 10 in the form of a cigarette and possessing certain representative components of a smoking article that can contain Oriental tobacco materials of the present invention. The cigarette 10 includes a generally cylindrical rod 12 of a charge or roll of smokable filler material (e.g., about 0.3 to about 1.0 g of smokable filler material such as tobacco material) contained in a circumscribing wrapping material 16. The rod 12 is conventionally referred to as a “tobacco rod.” The ends of the tobacco rod 12 are open to expose the smokable filler material. The cigarette 10 is shown as having one optional band 22 (e.g., a printed coating including a film-forming agent, such as starch, ethylcellulose, or sodium alginate) applied to the wrapping material 16, and that band circumscribes the cigarette rod in a direction transverse to the longitudinal axis of the cigarette. The band 22 can be printed on the inner surface of the wrapping material (i.e., facing the smokable filler material), or less preferably, on the outer surface of the wrapping material.

At one end of the tobacco rod 12 is the lighting end 18, and at the mouth end 20 is positioned a filter element 26. The filter element 26 positioned adjacent one end of the tobacco rod 12 such that the filter element and tobacco rod are axially aligned in an end-to-end relationship, preferably abutting one another. Filter element 26 may have a generally cylindrical shape, and the diameter thereof may be essentially equal to the diameter of the tobacco rod. The ends of the filter element 26 permit the passage of air and smoke therethrough. A plug wrap 28 enwraps the filter element and a tipping material (not shown) enwraps the plug wrap and a portion of the outer wrapping material 16 of the rod 12, thereby securing the rod to the filter element 26.

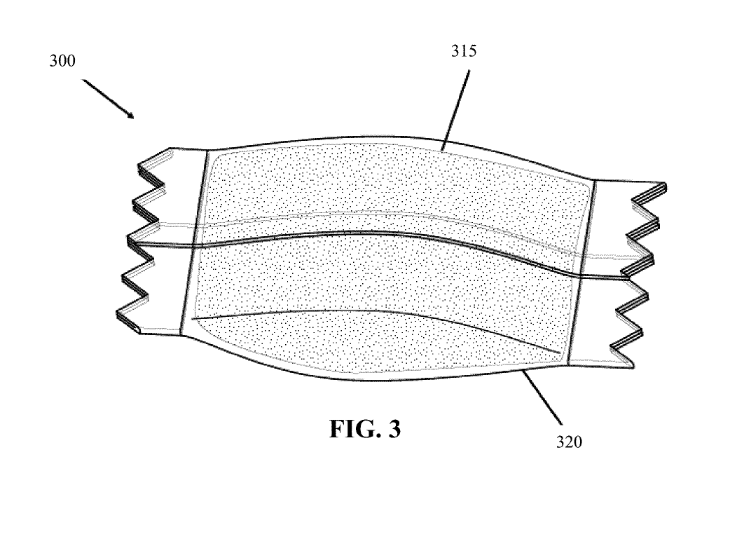

In various embodiments, smokeless tobacco products can comprise Oriental tobacco materials produced according to the methods outlined herein. The form of the smokeless tobacco product of the invention can vary. In one particular embodiment, the product is in the form of a snus-type product containing a particulate tobacco material containing Oriental tobacco provided according to the disclosed methods and other ingredients known in the art. Manners and methods for formulating snus-type tobacco formulations will be apparent to those skilled in the art of snus tobacco product production. For example, as illustrated in FIG. 3, an exemplary pouched product 300 can comprise an outer water-permeable container 320 in the form of a pouch which contains a particulate mixture 315 adapted for oral use. The orientation, size, and type of outer water-permeable pouch and the type and nature of the composition adapted for oral use that are illustrated herein are not construed as limiting thereof.

In various embodiments, a moisture-permeable packet or pouch can act as a container for use of the composition within. The composition/construction of such packets or pouches, such as the container pouch 320 in the embodiment illustrated in FIG. 3, may be varied as noted herein. For example, suitable packets, pouches or containers of the type used for the manufacture of smokeless tobacco products, which can be modified according to the present invention, are available under the tradenames CatchDry, Ettan, General, Granit, Goteborgs Rape, Grovsnus White, Metropol Kaktus, Mocca Anis, Mocca Mint, Mocca Wintergreen, Kicks, Probe, Prince, Skruf and TreAnkrare. A pouch type of product similar in shape and form to various embodiments of a pouched product described herein is commercially available as ZONNIC (distributed by Niconovum AB). Additionally, pouch type products generally similar in shape and form to various embodiments of a pouched product are set forth as snuff bag compositions E-J in Example 1 of PCT WO 2007/104573 to Axelsson et al., which is incorporated herein by reference, which are produced using excipient ingredients and processing conditions that can be used to manufacture pouched products as described herein.

The relative amount of Oriental tobacco material within a smokeless tobacco product may vary, and depends in part on the type of tobacco material employed (e.g., milled tobacco or tobacco extract). Preferably, the total amount of tobacco material (from any source, including tobacco extracts or isolates and particulate tobacco material) within the smokeless tobacco product is between about 0.01 and about 40 weight percent based on total weight of the composition, more typically between about 0.2 and about 20 weight percent (e.g., between about 0.3 and about 10 weight percent). For embodiments containing a tobacco extract as the only tobacco component, the smokeless tobacco product will typically contain no more than about 10 weight percent of the tobacco component, such as no more than about 8 weight percent, no more than about 5 weight percent, or no more than about 3 weight percent (e.g., about 0.01 to about 10 weight percent). For embodiments containing an Oriental particulate tobacco component (e.g., a finely milled tobacco), either as the sole tobacco component or in combination with a tobacco extract, the smokeless tobacco product will typically contain no more than about 20 weight percent of tobacco component, such as no more than about 15 weight percent, no more than about 10 weight percent, or no more than about 8 weight percent (e.g., about 1 to about 12 weight percent). The amount of tobacco material including Oriental tobacco material (or combination of tobacco material with other botanical components) in a smokeless tobacco product will typically not exceed 50 weight percent.

The invention is not limited to snus-type smokeless tobacco products. For example, Oriental tobacco materials can also be incorporated into various smokeless tobacco forms such as loose moist snuff, loose dry snuff, chewing tobacco, pelletized tobacco pieces, extruded tobacco strips or pieces, finely divided or milled agglomerates of powdered pieces and components, flake-like pieces (e.g., that can be formed by agglomerating tobacco formulation components in a fluidized bed), molded tobacco pieces (e.g., formed in the general shape of a coin, cylinder, bean, cube, or the like), pieces of tobacco-containing gum, products incorporating mixtures of edible material combined with tobacco pieces and/or tobacco extract, products incorporating tobacco (e.g., in the form of tobacco extract) carried by a solid inedible substrate, and the like. For example, the smokeless tobacco product can have the form of compressed tobacco pellets, multi-layered extruded pieces, extruded or formed rods or sticks, compositions having one type of tobacco formulation surrounded by a different type of tobacco formulation, rolls of tape-like films, readily water-dissolvable or water-dispersible films or strips (see, for example, U.S. Pat. No. 9,675,548 to Chan et al.), or capsule-like materials possessing an outer shell (e.g., a pliable or hard outer shell that can be clear, colorless, translucent or highly colored in nature) and an inner region possessing tobacco or tobacco flavor (e.g., a Newtonian fluid or a thixotropic fluid incorporating tobacco of some form).

In some embodiments, smokeless tobacco products incorporating Oriental tobacco material can have the form of a lozenge, tablet, microtab, or other tablet-type product. See, for example, the types of lozenge formulations and techniques for formulating or manufacturing lozenges set forth in U.S. Pat. No. 4,967,773 to Shaw; U.S. Pat. No. 5,110,605 to Acharya; U.S. Pat. No. 5,733,574 to Dam; U.S. Pat. No. 6,280,761 to Santus; U.S. Pat. No. 6,676,959 to Andersson et al.; U.S. Pat. No. 6,248,760 to Wilhelmsen; and U.S. Pat. No. 7,374,779; US Pat. Pub. Nos. 2001/0016593 to Wilhelmsen; 2004/0101543 to Liu et al.; 2006/0120974 to Mcneight; 2008/0020050 to Chau et al.; 2009/0081291 to Gin et al.; and 2010/0004294 to Axels son et al.; which are incorporated herein by reference.

In various embodiments, Oriental tobacco materials can be incorporated into an electronic smoking article. There have been proposed numerous smoking products, flavor generators, and medicinal inhalers that utilize electrical energy to vaporize or heat a volatile material, or attempt to provide the sensations of cigarette, cigar, or pipe smoking without burning tobacco to a significant degree. See, for example, the various alternative smoking articles, aerosol delivery devices and heat generating sources set forth in the background art described in U.S. Pat. No. 7,726,320 to Robinson et al., U.S. Pat. Pub. Nos. 2013/0255702 to Griffith Jr. et al., 2014/0000638 to Sebastian et al., 2014/0060554 to Collett et al., 2014/0096781 to Sears et al., 2014/0096782 to Ampolini et al., and 2015/0059780 to Davis et al., which are incorporated herein by reference in their entireties.

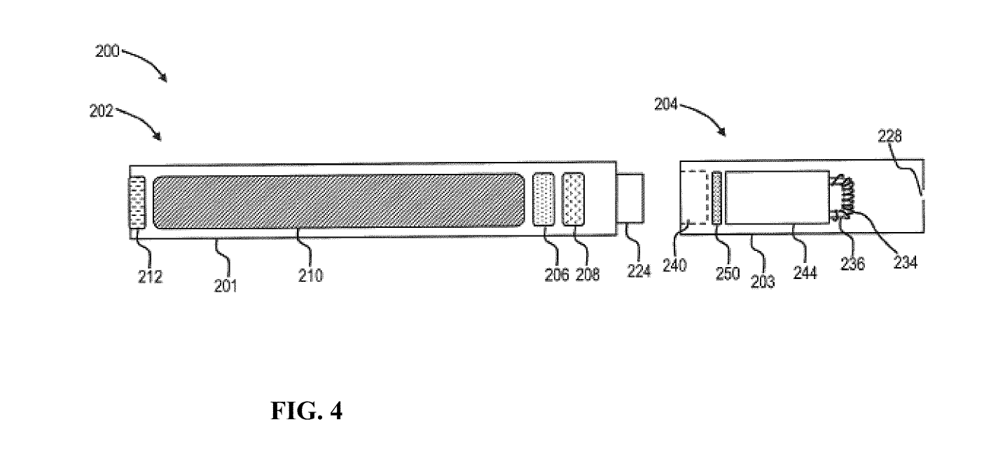

An exemplary embodiment of an electronic smoking article 200 is shown in FIG. 4. As illustrated therein, a control body 202 can be formed of a control body shell 201 that can include a control component 206, a flow sensor 208, a battery 210, and an LED 212. A cartridge 204 can be formed of a cartridge shell 203 enclosing a reservoir housing 244 that is in fluid communication with a liquid transport element 236 adapted to wick or otherwise transport an aerosol precursor composition stored in the reservoir housing to a heater 234. An opening 228 may be present in the cartridge shell 203 to allow for egress of formed aerosol from the cartridge 204. Such components are representative of the components that may be present in a cartridge and are not intended to limit the scope of cartridge components that are encompassed by the present disclosure. The cartridge 204 may be adapted to engage the control body 202 through a press-fit engagement between the control body projection 224 and the cartridge receptacle 240. Such engagement can facilitate a stable connection between the control body 202 and the cartridge 204 as well as establish an electrical connection between the battery 210 and control component 206 in the control body and the heater 234 in the cartridge. The cartridge 204 also may include one or more electronic components 250, which may include an IC, a memory component, a sensor, or the like. The electronic component 250 may be adapted to communicate with the control component 206. The various components of an electronic smoking device according to the present disclosure can be chosen from components described in the art and commercially available.

In various embodiments, the aerosol precursor composition can comprise an Oriental tobacco material. Exemplary formulations for aerosol precursor materials that may be used according to the present disclosure are described in U.S. Pat. No. 7,217,320 to Robinson et al.; U.S. Pat. Pub. Nos. 2013/0008457 to Zheng et al.; 2013/0213417 to Chong et al.; 2014/0060554 to Collett et al.; and 2014/0000638 to Sebastian et al., the disclosures of which are incorporated herein by reference in their entirety. Other aerosol precursors that can incorporate the Oriental tobacco materials described herein include the aerosol precursors that have been incorporated in the VUSE® product by R. J. Reynolds Vapor Company, the BLU™ product by Lorillard Technologies, the MISTIC MENTHOL product by Mistic Ecigs, and the VYPE product by CN Creative Ltd. Also desirable are the so-called “smoke juices” for electronic cigarettes that have been available from Johnson Creek Enterprises LLC.

### EXPERIMENTAL

Aspects of the present invention are more fully illustrated by the following examples, which are set forth to illustrate certain aspects of the present invention and are not to be construed as limiting thereof.

### Example 1

Oriental tobaccos are grown in traditional greenhouses in Climax, N.C. Basma, Katerini 53, and Izmir 51 are the tobacco types/varieties used in this trial.

Two greenhouses are used for the project with one house (“Greenhouse 1”) using organic potting soil medium in a bag shaped like a bucket and the second house (“Greenhouse 2”) using a coconut core medium. The organic potting soil medium contains a relatively high fertilizer charge. The coconut core medium contains no fertilizer charge. Water and organic fertilizer are applied to the plants using a traditional trickle tube system. The fertilizer is Neptune's Harvest 2-4-1, Allganic Sodium Nitrate 16-0-0, and organic potassium nitrate 0-0-51. The temperature in the greenhouse is held to 60° F. at night and ambient (90° F.) during the day. First harvest is 5 weeks after transplanting and then each week for the next 5 weeks.

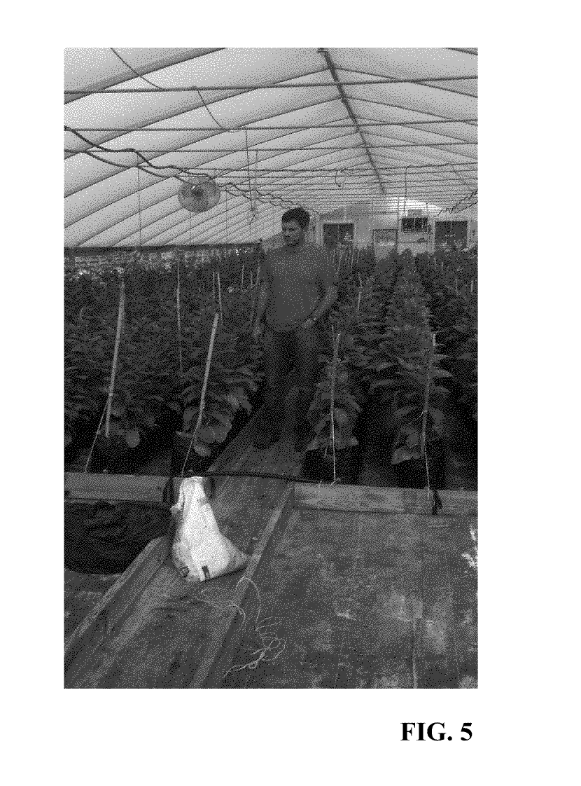

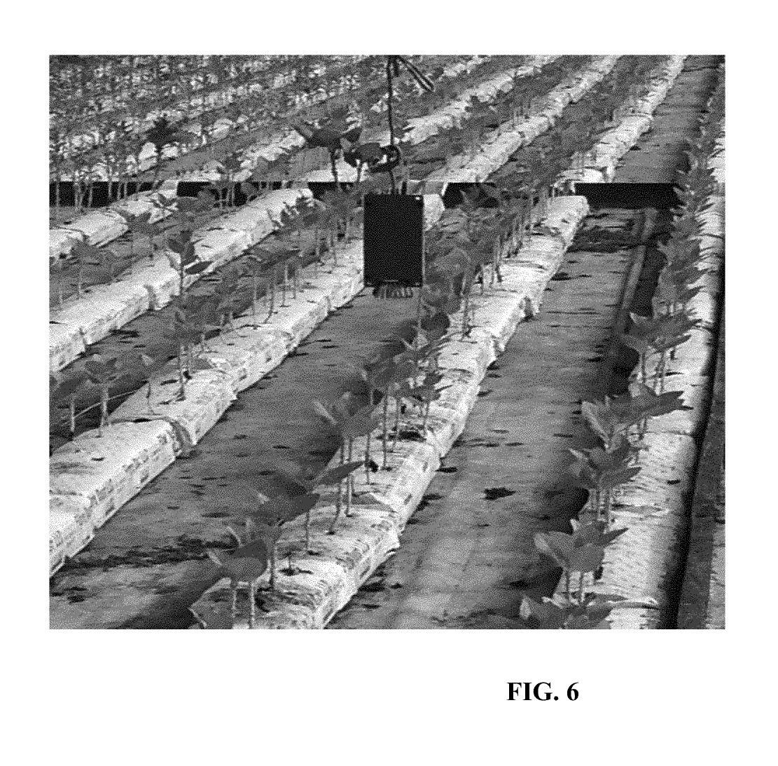

One harvest is made from Greenhouse 1 as only the upper most leaves had normal leaf characteristics. See, e.g., FIG. 5, depicting plants grown from organic potting soil media. Three harvests are made from Greenhouse 2. The plants in this greenhouse exhibited normal Oriental characteristics. See, e.g., FIG. 6, showing coconut bags prior to final harvest. The Oriental tobacco plants grown using organic potting soil medium grew too quickly and became too large. Without being limited by theory, it is believed that this was a result of the high fertilizer charge in the organic soil medium. The coconut core medium contains no fertilizer charge, which allows growers to accurately regulate the amount of fertilizer applied to the plants.

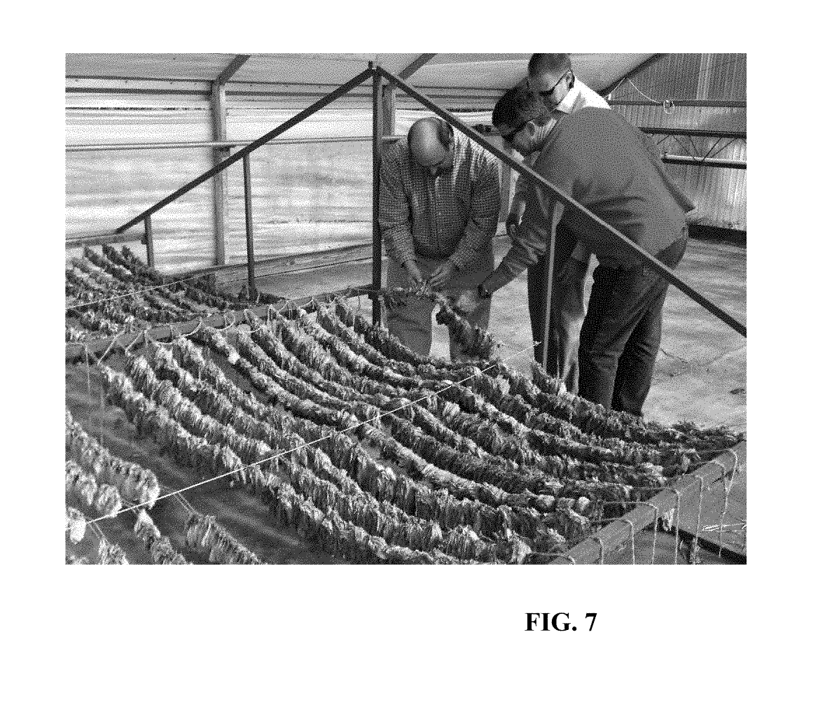

Multiple harvests are cured in Greenhouse 2 using a traditional Oriental curing structure. See, e.g., FIG. 7. After curing is complete, samples are tested for leaf chemistry and sample cigarettes are made to evaluate smoke characteristics. Alkaloids of the smoke are between 0.15-0.63% and reducing sugars are in a range from about 5-28%. This is based on weight and is in the range of traditional Oriental tobacco. Alkaloids represents of the amount of nicotine in the plant plus nornicotine types of alkaloids (virtually all nicotine). Sugars are created during the curing process as starch in the leaf is converted to sugar. See Tobacco Production, Chemistry and Technology: Ed. Davis, D. L., and M. T. Nielson, pp. 154-163. Pub. 1999.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of growing Oriental tobacco, comprising:
receiving a plurality of Oriental tobacco seeds;
planting the plurality of Oriental tobacco seeds in one or more containers, wherein the containers are located in a greenhouse structure configured to maintain a first temperature of approximately 50-100° F., and a humidity of approximately 50-60%;
allowing the seeds to grow into seedlings at least about 4 inches in height;
transplanting the seedlings into a coconut core medium, wherein the coconut core medium is located in a greenhouse structure configured to maintain a second temperature of approximately 50-100° F., and a humidity of approximately 50-60%; and
allowing the seedlings to grow into Oriental tobacco plants.

2. The method of claim 1, further comprising harvesting the Oriental tobacco plants to provide harvested Oriental tobacco leaves.

3. The method of claim 2, further comprising curing the harvested Oriental tobacco leaves.

4. The method of claim 3, further comprising aging the harvested Oriental tobacco leaves.

5. The method of claim 1, wherein the first temperature is varied between a first setting and a second setting over the course of a 24 hour cycle.

6. The method of claim 5, wherein the first setting is approximately 50-70° F.

7. The method of claim 5, wherein the second setting is approximately 80-100° F.

8. The method of claim 1, wherein the second temperature is varied between a first setting and a second setting over the course of a 24 hour cycle.

9. The method of claim 8, wherein the first setting is approximately 50-70° F.

10. The method of claim 8, wherein the second setting is approximately 80-100° F.

11. The method of claim 1, wherein the seedlings are allowed to grow until they are approximately 5 inches in height.

12. The method of claim 1, further comprising incorporating the Oriental tobacco into a tobacco product.

13. The method of claim 12, wherein the tobacco product is a smoking article.

14. The method of claim 13, wherein the smoking article has sensory characteristics comparable to those of a smoking article incorporating Oriental tobacco grown in Mediterranean or Asian regions using conventional growth methods.

15. The method of claim 12, wherein the tobacco product is a smokeless tobacco product.
